(19) United States
(12) Patent Application Publication
(10) Pub. No.: US 2016/0334630 A1
(43) Pub. Date: Nov. 17, 2016

(54) FILTER FOR A TELEPROMPTER OR OTHER DISPLAY

(71) Applicant: Big Dog Prompters, LLC, New York, NY (US)

(72) Inventors: Evan Hershman, New York, NY (US); Matt Richman, New York, NY (US); Mark Shearon, New York, NY (US)

(21) Appl. No.: 14/710,887

(22) Filed: May 13, 2015

(51) Int. Cl. G02B 27/02

(52) U.S. Cl. CPC G02B 27/02; G02B 2207/123

(57) ABSTRACT

A filter for a display comprising at least one cellular grid positioned substantially parallel to and at a predetermined distance from the display, such that when a user views the display through the cellular grid(s) and from within a predetermined range of viewing angles corresponding to the predetermined distance, the display is visible to the user, but the cellular grid(s) prevents others outside the predetermined range of viewing angles from viewing the display.

### TECHNICAL FIELD

The present invention generally relates to a filter for a display device. More specifically, the present invention relates to a teleprompter which includes a filter that limits the visibility of a displayed image to users within a predetermined range of viewing angles, and obscures the displayed image outside the predetermined range of viewing angles.

### BACKGROUND OF THE INVENTION

Displays are common in many areas of work and everyday life. Examples of displays include televisions, video display units, teleprompters, liquid crystal displays, etc. It is not unusual for such a device to display sensitive or confidential information that a user may want to restrict others from viewing. Examples of such uses include automated teller machines, display units at financial institutions or medical offices, and teleprompters used at speaking engagements. When a teleprompter is used, the speaker, of course, does not want the audience to realize that he she is reading text from a display.

Consequently, there is a need for a filter that restricts the visibility of an image on a display device to a predetermined range of viewing angles near normal incidence, while obscuring the image at angles outside of the range. There are several devices currently available on the market that include thin-film privacy filters, panels, displays with built-in filters, polarizers and teleprompters with directional screens. However, all of these devices are expensive or only available for relatively small displays.

Therefore, there is a need for a filter that is available in a variety of sizes, does not reduce contrast, and is relatively inexpensive.

### SUMMARY OF THE INVENTION

It is an object of the present invention to provide a filter for a display device. It is a further object of the invention to provide a teleprompter with a filter that limits the visibility to a user within a predetermined range of viewing angles and obscures the displayed image outside that range.

In accordance with one embodiment of the present invention, a filter comprising a cellular grid is positioned substantially parallel to and a predetermined distance from a display, such that when a user views the display through the cellular grid and from within a predetermined range of viewing angles corresponding to the predetermined distance, the display is visible to the user, but the cellular grid prevents others outside the predetermined range of viewing angles from viewing the display.

In accordance with another embodiment of the present invention, a filter comprises two cellular grids aligned in parallel and a predetermined distance apart, such that when the filter is placed in front of a display screen, the display is viewable to a user through both cellular grids. Further, the filter is placed at a predetermined distance from and substantially parallel to the display, such that when viewed from outside a predetermined range of viewing angles, the display is not visible through the cellular grid to others.

### BRIEF DESCRIPTION OF THE DRAWINGS

The features and advantages of the present invention can be more readily understood from the following detailed description with reference to the accompanying drawings, wherein:

FIG. 1 is an elevated view of the invention.

FIG. 2 is an exemplary isometric view illustrating an embodiment of the invention.

FIG. 3 is an exemplary isometric view illustrating another embodiment of the invention.

FIG. 4 is a top view illustrating an embodiment of the present disclosure and an exemplary predetermined viewing angle.

FIG. 5 is a top view illustrating another embodiment of the present invention and an exemplary predetermined viewing angle.

FIG. 6 is a diagram illustrating viewing cones, formed between a filter placed in front of a display and a user positioned some distance away, within which a displayed image would be clearly visible to a user, while the displayed image is obscured to viewers outside the viewing cones.

FIG. 7 illustrates an exemplary cellular grid having a honeycomb structure.

FIG. 8 is a tabular representation of empirically derived exemplary range of viewing angles based on various embodiments of the invention and the distance between a user and the display.

### DETAILED DESCRIPTION OF THE EMBODIMENTS

The present invention generally relates to a filter for a display. More particularly, a cellular grid placed in front of the display restricts the visibility of displayed images to users within a predetermined range of viewing angles incident to the cellular grid, and obscures the displayed image to those viewers outside that range.

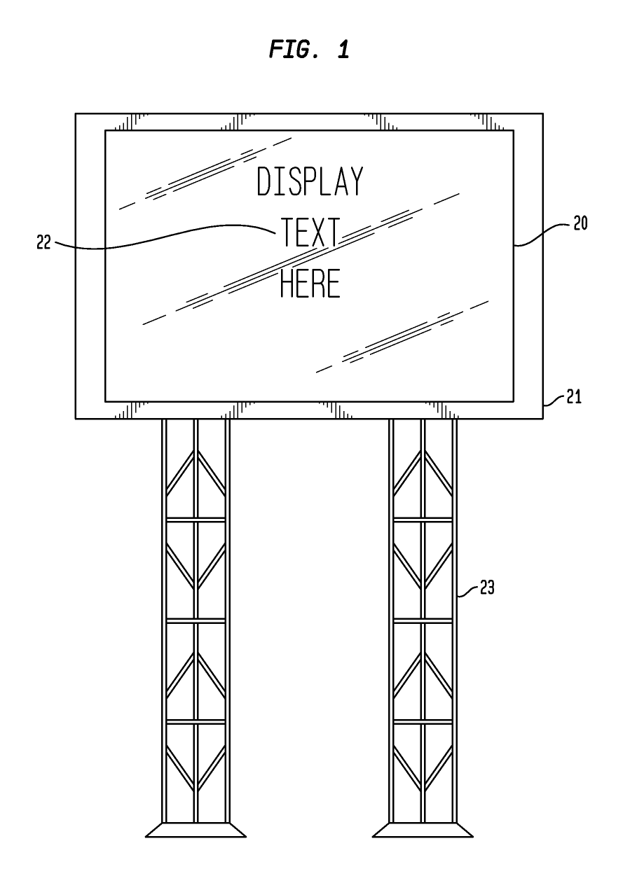

FIG. 1 illustrates a display 20 with an image 22 clearly visible through a filter 21, positioned on a stand 23, when viewed at a line of sight normal to the filter 21. Alternatively, the filter 21 and display 20 are positioned on a turntable so as to allow a user to change the orientation of the display with respect to a user without moving the stand 23. For example, if the user is pacing on a podium, he or she could view the display. The display could be quite large, for example, 80 inches diagonally, and positioned far away from a speaker, for example, more than 100 feet away.

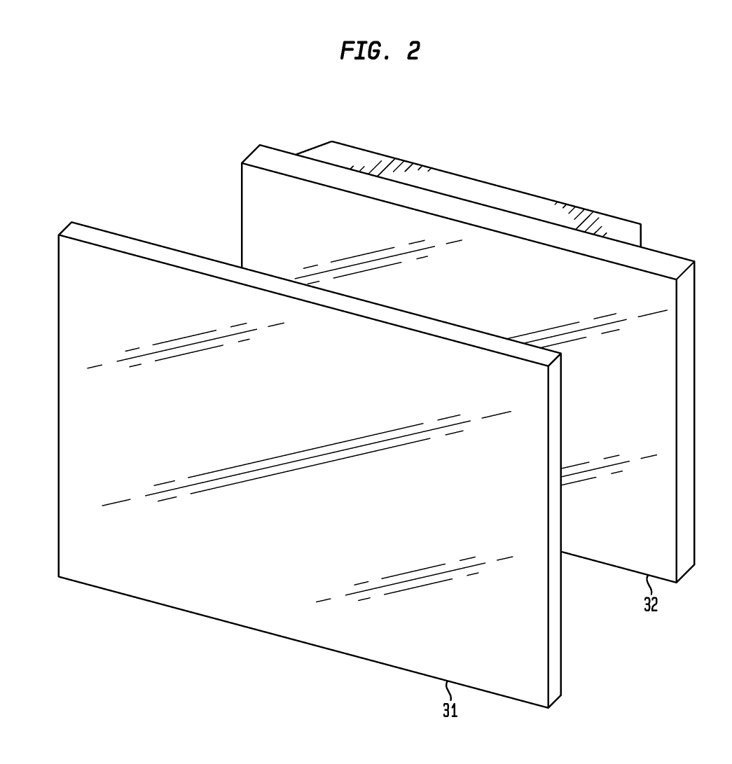

As shown in FIG. 2, the filter consists of a cellular grid 31 positioned substantially parallel to and at a predetermined distance from the display 32, wherein the predetermined distance corresponds to a predetermined range of viewing angles. The predetermined distance may be variable so as to change the predetermined range of viewing angles. Preferably, the viewing cone angle is about 2.5 degrees.

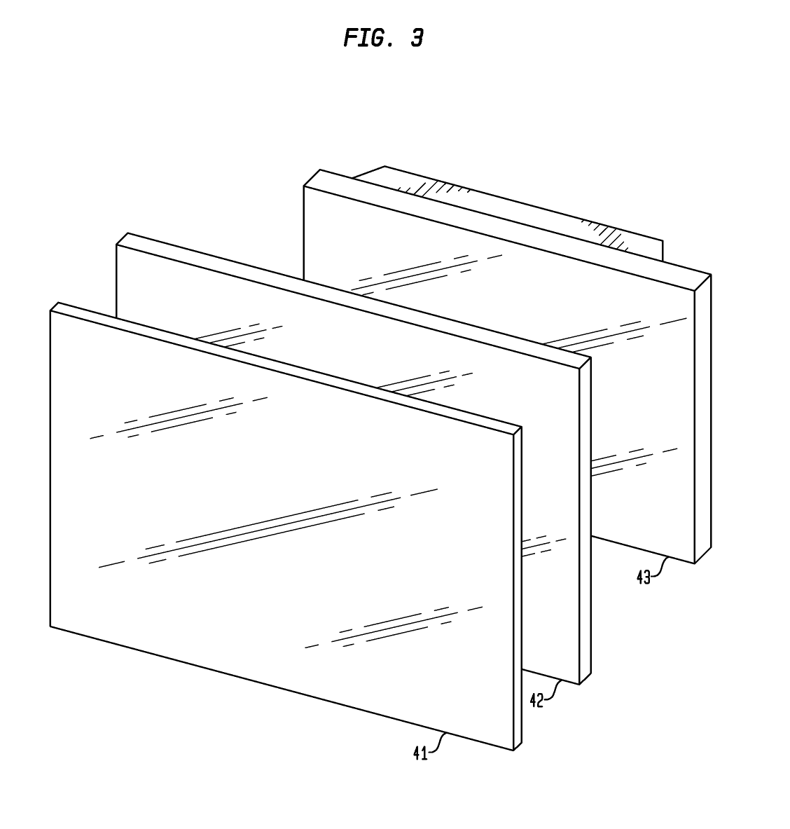

In another embodiment, illustrated in FIG. 3, the filter consists of a first cellular grid 41 and a second cellular grid 42 aligned in parallel and at a first predetermined distance apart, such that when the filter is placed in front of display 43, a displayed image is clearly visible to a user through both cellular grids. The first cellular grid 41 and second cellular grid 42 are placed substantially parallel and at a second predetermined distance from display 43 such that the displayed image is obscured to viewers outside the predetermined range of viewing angles. The first predetermined distance between first cellular grid 41 and second cellular grid 42 may be variable so as to change the predetermined viewing angle. The second predetermined distance between second cellular grid 42 and display device 43 also may be variable so as to change the predetermined range of viewing angles. The first cellular grid and second cellular grid may be of different thicknesses.

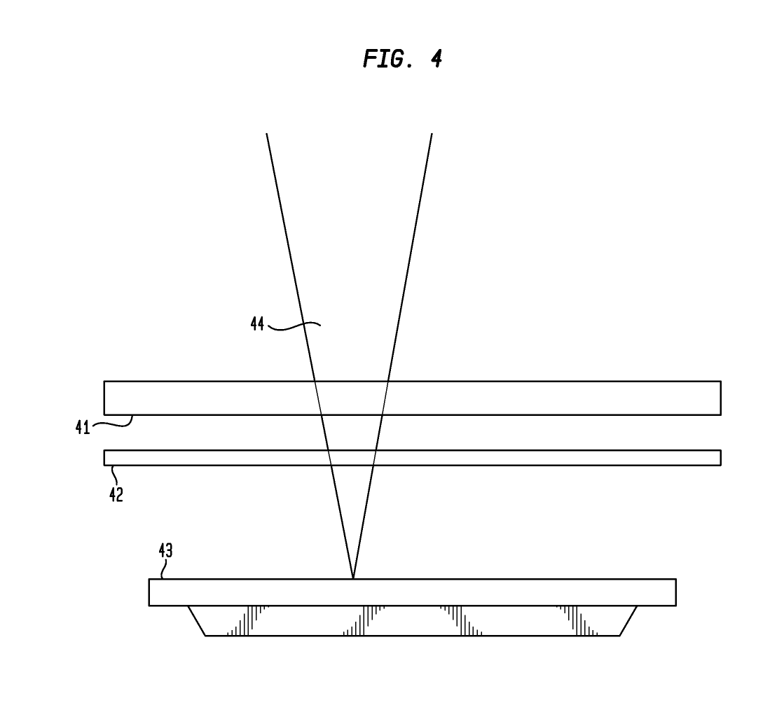

FIG. 4 is top view illustrating an exemplary viewing cone 44 corresponding to a predetermined viewing angle. Images displayed on display 43 are clearly visible through the filter, comprising first cellular grid 41 and second cellular grid 42, to a user positioned within the viewing cone 44 while the displayed image is obscured to viewers outside the viewing cone 44. It has been determined empirically that a useful configuration has the first grid positioned about 1 inch from the display, the first and second grid positioned 10 inches apart, and the first grid is 1 inch thick and the second grid is 2 inches thick.

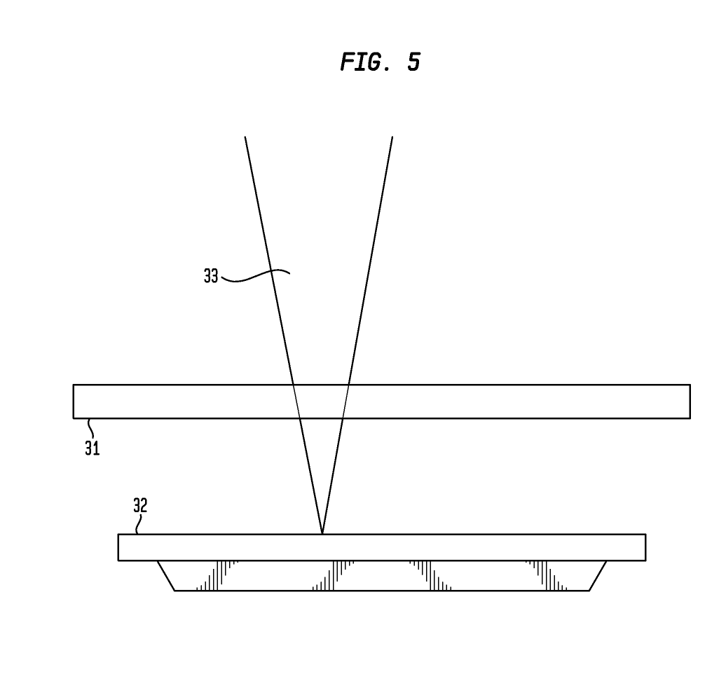

FIG. 5 is a top view illustrating an exemplary viewing cone 33 corresponding to a predetermined viewing angle. Images displayed on display unit 32 are clearly visible through the filter 31 to a user positioned within the viewing cone 33 while the displayed image is obscured to viewers outside the viewing cone 33.

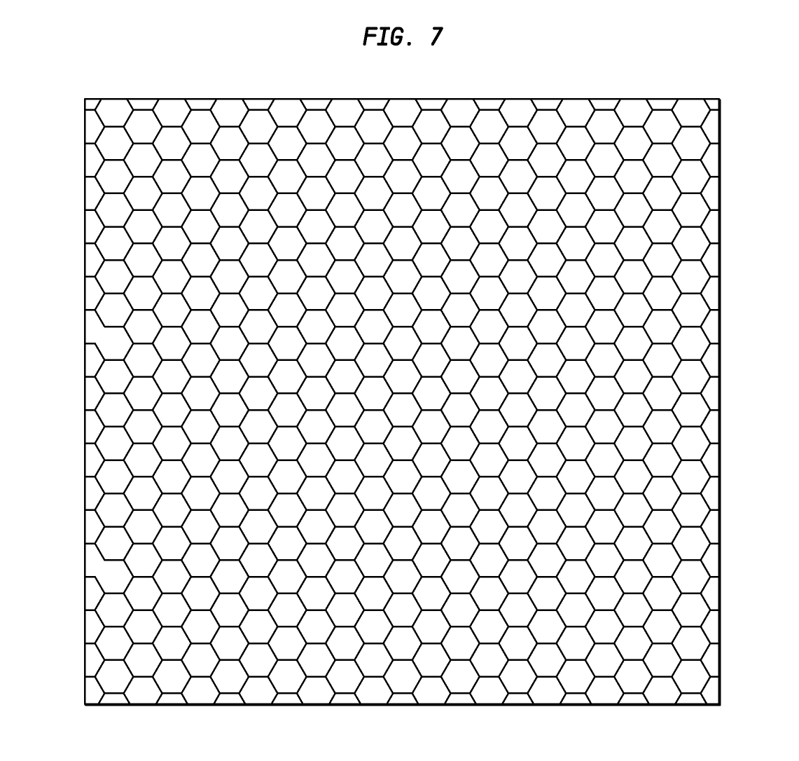

FIG. 7 illustrates a cellular grid, the cellular grid preferably has a honeycomb structure with the hexagonal-shaped cells. The cells may be of other shapes and sizes, including squares, triangles, a combination thereof, etc.

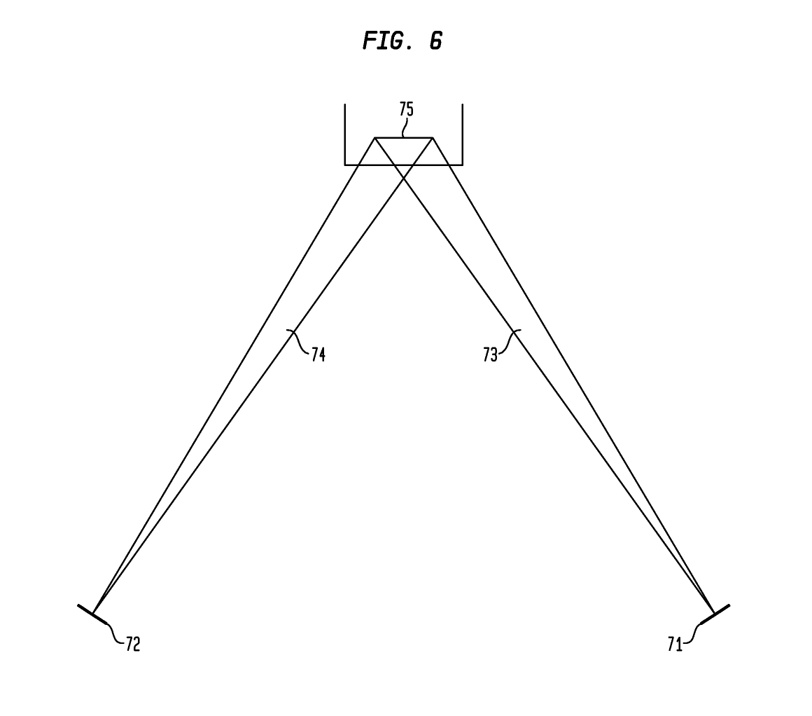

FIG. 6 illustrates viewing cones 73, 74 extending from displays and filters 71, 72 to a user positioned at a podium 75. An image displayed on units 71, 72 will be clearly visible to users within viewing cones 73, 74 while the displayed image on units 71, 72 will be obscured to viewers outside the viewing cones 73, 74. One cellular grid that has been found useful for the present purposes is a honeycomb structure made by Texas Almet LP.

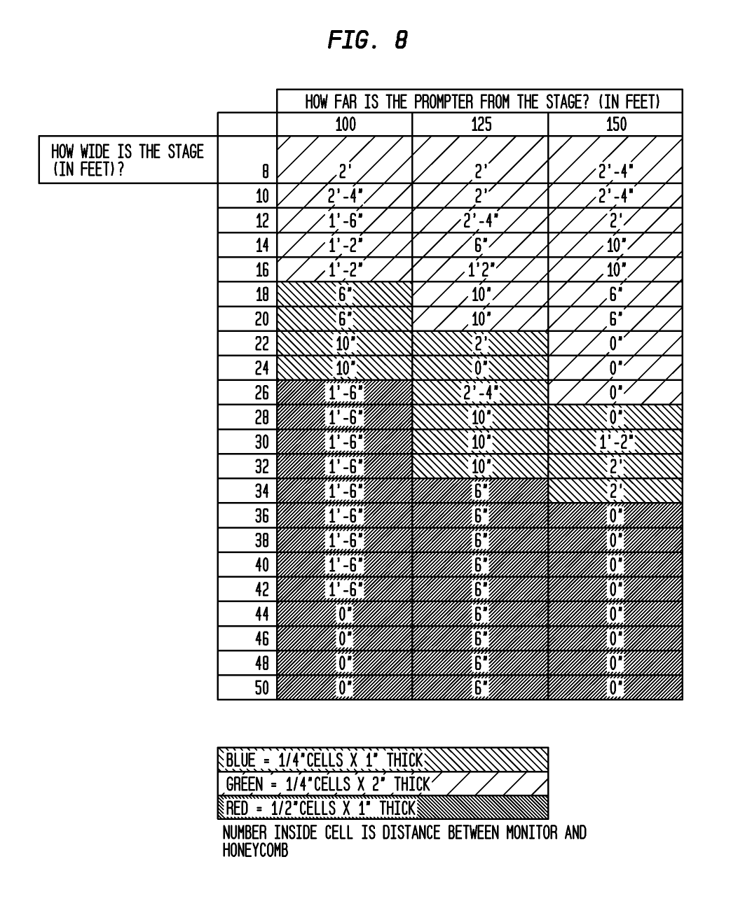

It has been determined empirically that, for example, a 1 inch thick cellular grid with ¼-inch honeycomb cells placed 6 inches from a display creates viewing cones 73, 74 between displays and filters 71, 72 placed 100 feet away from an 18 inch wide podium 75. An image displayed on units 71, 72 is clearly visible to a user within viewing cones 73, 74 while the displayed image is obscured to viewers outside the viewing cones. Similarly, a 2 inch thick cellular grid with ¼-inch honeycomb cells placed 14 inches from a display unit creates viewing cones 73, 74 between displays and filters 71, 72 placed 125 feet away from a 16 inch wide podium 75. An image displayed on units 71, 72 is clearly visible to a user within viewing cones 73, 74 while the displayed image is obscured to viewers outside the viewing cones. FIG. 8 represents additional, empirically derived exemplary ranges of viewing angles corresponding to various embodiments of the invention and the distance between a user and the filter and display.

Other variations of the invention may be used without departing from the spirit and scope of the invention.

What is claimed:

1. A filter for a display comprising a cellular grid positioned substantially parallel to and at a predetermined distance from the display, such that when a user views the display through the cellular grid and from within a predetermined range of viewing angles corresponding to the predetermined distance, the display is visible to the user, but the cellular grid prevents others outside the predetermined range of viewing angles from viewing the display.

2. The filter of claim 1 wherein the predetermined distance between the cellular grid and display is variable so as to change the range of viewing angles.

3. The filter of claim 1 wherein the filter and display are mounted on a turntable so as to maintain a non-stationary user of the display within the predetermined range of viewing angles.

4. The filter of claim 1 wherein the display is a liquid crystal display, teleprompter, LED display, television, tablet, smart phone, or other electronic display.

5. The filter of claim 1 wherein the cellular grid is a honeycomb structure.

6. The filter of claim 1 wherein the cellular grid comprises two parallel honeycomb structures.

7. A filter for a display unit comprising:
a first cellular grid;
a second cellular grid;
the first and second cellular grids are aligned in parallel and a predetermined distance apart, such that when the filter is placed in front of a display screen, the display is viewable to a user through both cellular grids; and
the first and second cellular grids are placed at a predetermined distance from and substantially parallel to the display, such that when viewed from outside a predetermined range of viewing angles, the display is not visible to others through the cellular grids.

8. The filter of claim 6 wherein the predetermined distance between the cellular grids and the display is variable so as to change the range of viewing angles.

9. The filter of claim 6 wherein the predetermined distance between the first and second cellular grids is variable so as to change the range of viewing angles.

10. The filter of claim 6 wherein the predetermined distance between the first and second cellular grids is variable and the predetermined distance between the cellular grid and display is variable, so as to change the range of viewing angles.

11. The filter of claim 6 wherein the filter and display are mounted on a turntable so as to maintain a non-stationary user of the display within the predetermined range of viewing angles.

12. The filter of claim 6 wherein the display is a liquid crystal display, teleprompter, LED display, television, tablet, smart phone, or other electronic display.

13. The filter of claim 6 wherein the first and second cellular grids are honeycomb structures.

14. A filter for a display comprising a honeycomb grid positioned substantially parallel to and at a predetermined distance from the display, such that when a user views the display through the cells in the honeycomb grid and from within a predetermined range of viewing angles corresponding to the predetermined distance, the display is visible to the user, but the honeycomb grid prevents others outside the predetermined range of viewing angles from viewing the display.

15. A filter for a teleprompter comprising a cellular grid positioned substantially parallel to and at a predetermined distance from the teleprompter, such that when a user views the teleprompter through the cellular grid and from within a predetermined range of viewing angles corresponding to the predetermined distance, the teleprompter is visible to the user, but the cellular grid prevents others outside the predetermined range of viewing angles from viewing the teleprompter.

16. A teleprompter system comprising a display and a cellular grid positioned substantially parallel to and at a predetermined distance from the display, such that when a user views the display through the cellular grid and from within a predetermined range of viewing angles corresponding to the predetermined distance, the display is visible to the user, but the cellular grid prevents others outside the predetermined range of viewing angles from viewing the display.
